(19) United States
(12) Patent Application Publication
(10) Pub. No.: US 2016/0267804 A1
(43) Pub. Date: Sep. 15, 2016

(54) TRAINING AND COGNITIVE SKILL IMPROVING SYSTEM AND METHOD

(71) Applicant: Kadho Inc., Irvine, CA (US)

(72) Inventors: Dhonam Pemba, Toluca Lake, CA (US); Kaveh Azartash, Aliso Viejo, CA (US)

(21) Appl. No.: 14/657,867

(22) Filed: Mar. 13, 2015

(51) Int. Cl. G09B 7/02; A63F 13/67; G09B 5/02; A63F 13/428; A63F 13/355; A63F 13/822; A63F 13/2145

(52) U.S. Cl. CPC G09B 7/02; A63F 13/822; A63F 13/67; A63F 13/2145; A63F 13/428; A63F 13/355; G09B 5/02

(57) ABSTRACT

An interactive cognitive skill improvement method and system is provided wherein a real life video is deployed in a video game environment and interruptions are induced in the real life video to seek a response from a user based on the interruptions. The user is expected to predict a specific outcome or provide a specific response based on the scenario in the real life video. The video game environment is enabled to compare the user's response with the actual outcome in the real life video and the user's performance is analyzed and recorded for future reference.

### CROSS REFERENCE TO RELATED APPLICATIONS

NOT APPLICABLE

### BACKGROUND

In today's world sharp cognitive skills have become highly desirable in many walks of life including but not limited to a variety of sports, firefighting, police functions, armed forces, flying aircrafts, tactical warfare, etc. Research has shown over the years that various methods can be employed to train personnel to improve their cognitive skills Some of the well-known methods include on field training, concentration and perception building, physical and mental exercises, etc. Trainers and coaches also rely on specific opponent analysis and train their teams and personnel by creating similar environment on field. However, these activities are effective only to a small extent and their objective is general overall cognitive skill enhancement without specificity.

The need of highly specific cognitive skill development has lead to the insurgence of supplementary cognitive skill building activities due to their capability to nurture and improve cognitive skills for very specific scenarios. Among these, one of the most popular techniques is the interactive video occlusion training that is used to enhance cognitive capabilities by seeking rapid responses to custom paced simulated or animated videos. A plethora of video games are known in the prior art that create simulated game environment for specific games like baseball, cricket etc. These video games create an interruption during a simulated game and then seek a response from the player playing the game. The player's response is analyzed and compared to the ideal outcome. These simulated and/or animated video games suffer from a few disadvantages that affect their effectiveness in achieving the desired objective of skill enhancement. Two prominent disadvantages are firstly, a simulated or animated video cannot replicate a real life scenario to perfection as it cannot take into account all the environmental and other factors that affect a real life outcome and secondly, most of these video games have limited interactive capability mostly in the form of response input through game controllers, keyboards or other input devices which are highly ineffective in seeking accurate and rapid responses and even the variety of responses that can be sought are very limited. Another limitation that severely affects these video games is lack of detailed and in depth analysis to track the performance of the players.

### SUMMARY OF THE INVENTION

The present invention relates to a computer implemented training and cognitive skill improving method for training users for specific activities and scenarios and a corresponding system thereof. The method comprises deploying a real life video in a video game environment wherein such real life video may have been previously recorded, presenting the video game environment comprising of said real life video to a user, creating an interruption in the real life video deployed in the video game environment, soliciting the user's response to predict an outcome for a specific scenario and comparing the user's response with the actual outcome in the real life video. In accordance with one aspect of the present invention, the method further comprises of storing and analyzing the user's response to measure improvement in cognitive and other skills of the user. The difficulty level of the game may be increased or decreased based on the user's performance. In one embodiment of the current invention, the method may further comprise inducing distraction factors to increase the difficulty level. The method further comprises displaying performance analysis by highlighting active brain areas on a brain map image corresponding to user's response to specific tasks. In one embodiment of the present invention, the real life videos may be automatically deployed in the video game environment based on parameters defined by the user. Once the real life video is deployed in the game environment and is presented to the user, the interruption in the real life video is caused using temporal occlusion or by pausing the real life video at a specific point or presenting a blank screen to the user at a specific point. In one embodiment of the invention, the response may be sought from the user using touch interface of a computing or mobile device or by using augmented reality display by capturing user's gestures.

In accordance with one aspect of the present invention, described herein is training and cognitive skill improving system comprising a storage means for storing real life videos, a processor for deploying the real life videos from the storage means into a video game environment, a video display screen for presenting the video game environment consisting of the real life video to a user and an input means for soliciting response from the user based on interruption of the real life video. In one embodiment of the invention, the storage means is a cloud server storage. In another embodiment of the present invention the input means for soliciting response is a touch interface of a computing or mobile device. In yet another embodiment of the present invention, the input means for soliciting response is an augmented reality system capturing said user's gestures.

### BRIEF DESCRIPTION OF THE DRAWINGS

FIG. 1 is an illustrative screen shot of the menu page of the video game environment that relates to the sport of Volleyball

FIG. 2 illustrates the broad network level flow chart of one embodiment of the invention.

FIG. 3a is an illustrative screen shot of a volleyball real life video deployed in the video game environment. FIG. 3b depicts the user's response to a question asked to the user based on a volleyball scenario. FIG. 3c depicts the user's response to draw the path of the ball once the video is paused. FIG. 3d illustrates the user's response of predicting player or ball direction based on pressing left, right, up or down.

FIG. 4 is an illustrative screen shot of a volleyball real life video wherein solution to user response is displayed.

FIG. 5 illustrates a logic followed by the video game environment to increase or decrease the difficulty level of the game based on user performance.

FIG. 6 is an illustrative screen shot of performance data and analytics display using a brain image.

### DETAILED DESCRIPTION

The embodiments herein and the various features and advantageous details thereof are explained with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the scope of this patent application and the claims contained herein should not be construed as limited to the illustrative embodiments.

The training and cognitive skill improving method disclosed herein provides for a video game environment hosted on a computing or mobile device that has the capability of integrating real life videos for training a user. The video game environment may be understood as any environment hosted on a device capable of engaging a user to solicit user's response. The video game may be played on any computing or mobile device with a video display screen, a processor and storage either in the form of cloud storage or device's own storage drive where the real life videos to be utilized in the video game environment are stored. The video game environment lets the user choose a real life video or picks the real life video automatically based on requirements or parameters entered by the user. For example, the user may choose to practice returns for tennis serves from a specific opponent and may deploy previously recorded videos of the opponent. The real life videos may be deployed and newer videos may be added by storing the videos and corresponding Solutions on a database. This database may either be locally stored on the device or on the cloud server. Here the term ‘Solutions’ refers to a video with the results graphed on it with analytics. The Solutions file lets the user interact with the video and provides an analysis of the user's response. Once the previously recorded real life video and the corresponding Solution are stored in the database, a deployment tool enables the user to choose the video and interact with it. If the user wants to upload new videos, the user can add details of each video and the corresponding Solutions file to the database and the video will be ready for deployment in the video game environment.

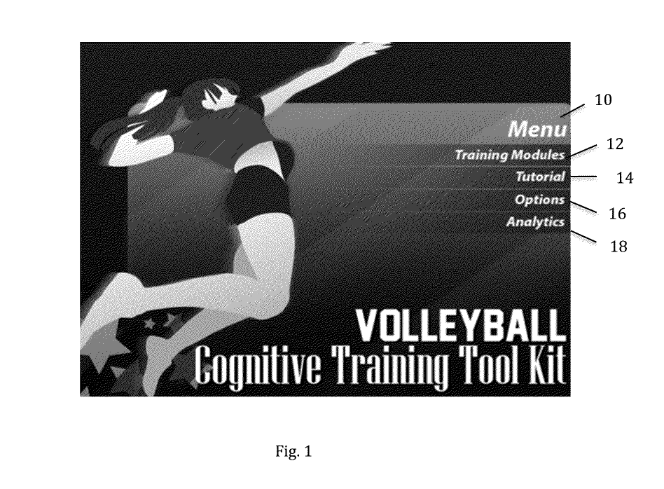

FIG. 1 is an illustrative screen shot of the menu page of the video game environment that relates to the sport of Volleyball. Being a fast paced game with an expected reaction time of milliseconds, Volleyball has been taken as an example throughout this patent application. The menu 10 comprises of various categories that a user may choose from, including but not limited to training modules 12, tutorial 14, options 16 and analytics 18. The training modules tab 12 provides the user an option of choosing from various real life videos stored either on the device's storage drive or on the cloud. The user may decide to pick a particular type of videos to train upon a specific aspect of the game. Alternatively, in one embodiment of the invention, the user may enter parameters like ‘Practice Ball Bath Prediction’ or ‘Practice Hit and Tip’ and the game may choose corresponding videos automatically based on previous categorization of the real life videos in various categories. A more advanced user may have the further option of choosing varying difficulty levels. Alternatively, the user may choose to start from the basic difficulty level and the game may automatically and continuously increase or decrease the difficulty level based on the user's performance on the previous level. The tutorial 14 trains the user on how to navigate through the video game environment and use the various features of the game. Among others, it may further train the user on how to deploy and use newly recorded real life videos for the training module. The options 16 tab on the menu 10 may be used by the user to choose various device and game settings including but not limited to screen brightness, sound, level of interruption, resolution etc. The analytics tab 18 provides the user accessibility to the analytics dashboard where the user's current and previous performances are analyzed and the user may be given multiple options of viewing different types of analysis and results.

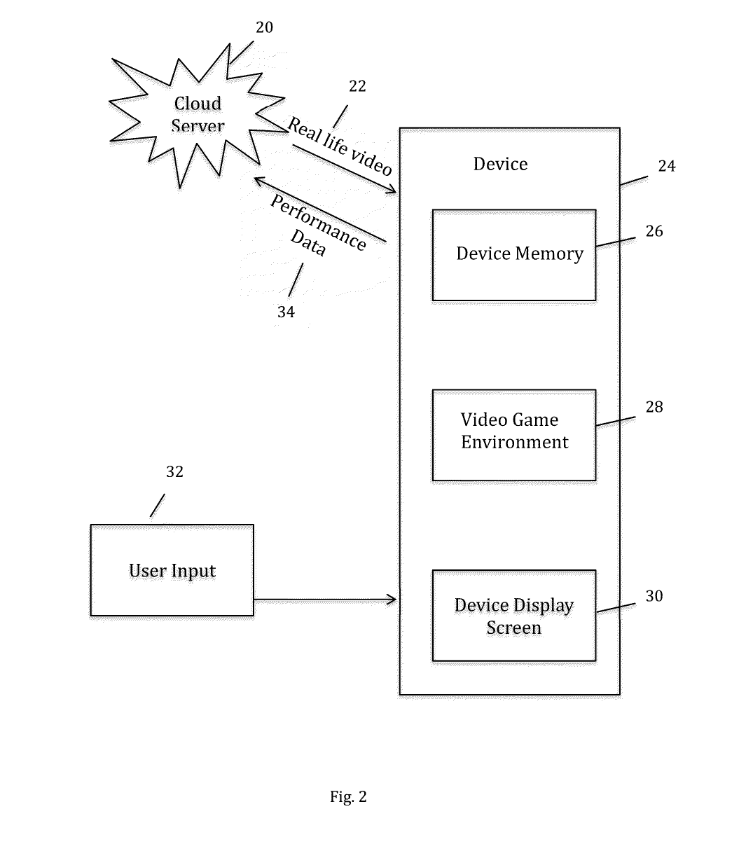

FIG. 2 illustrates the broad network level flow chart of one embodiment of the invention. The device 24 interacts with the cloud server 20 to optionally receive previously recorded real life videos 22 stored on the cloud server and in turn stores these real life videos 22 on the device memory 26. The device 24 hosts the video game environment 28 that is capable of deploying these real life videos 22 for user's training and cognitive skill development. The real life videos 22 once deployed by the video game environment 28 are displayed on the device display screen 30 for soliciting user's response based on interruptions induced in the real life video 22. The user input 32 is received using various input devices including but not limited to keyboard, mouse, game controller, touch interaction on the device display screen 30 and gestures using motion sensing augmented reality systems known in the art. The user's response is compared with the ideal outcome of the interrupted real life video 22 and the user's performance is analyzed and stored on the cloud server in the form of performance data 34. This performance data 34 may be accessed and utilized by coaches and trainers to track the skill improvement of a player or a user.

### Game Interaction

The training and cognitive skill building method disclosed herein is based on the principle of creating interruptions in an ongoing recorded real life video and soliciting a response from the user to predict a specific outcome. Different types of interruptions may be used to ensure all round cognitive skill building and better response under various environmental conditions including but not limited to crowd noise, wind, distractions etc.

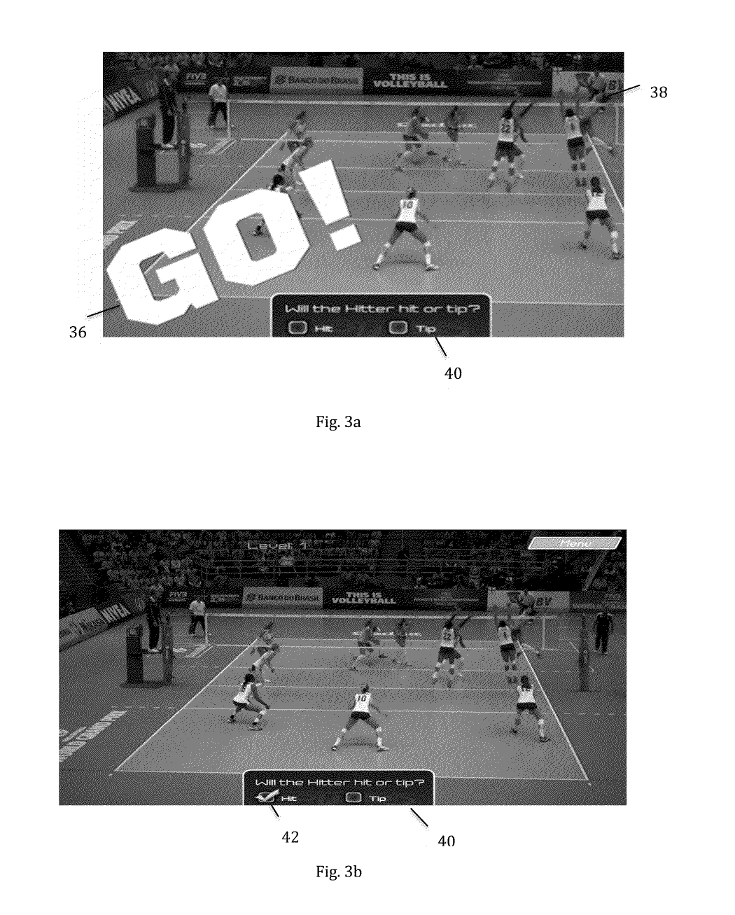

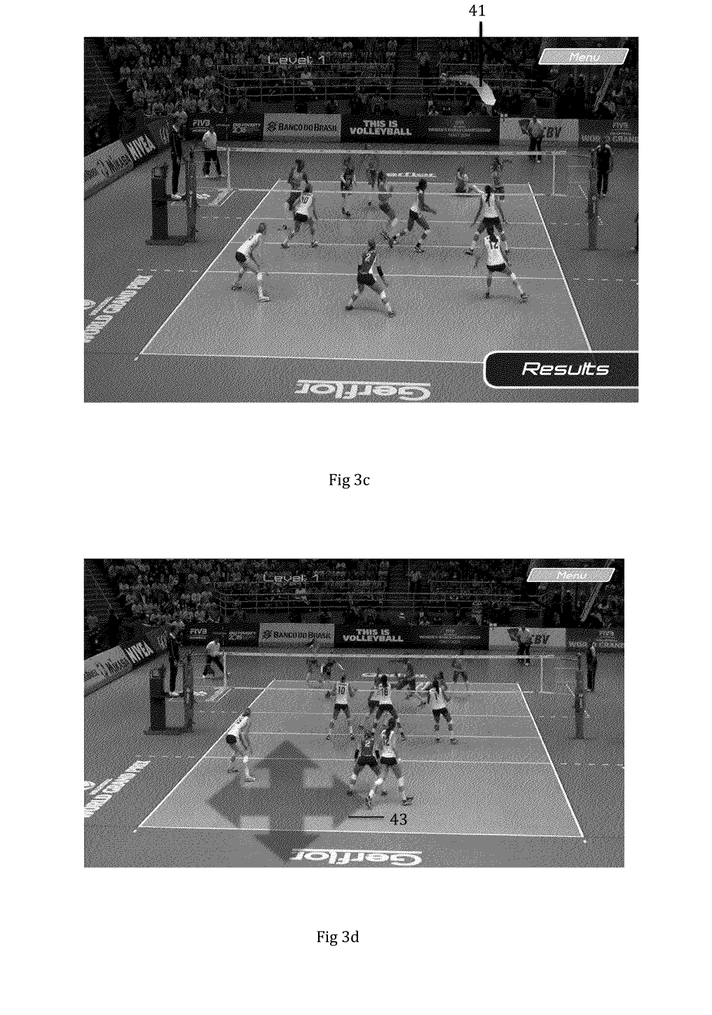

The game interruptions may involve the video being temporally occluded or paused at a certain time frame or a black/blank screen presented at a certain time frame and the user is expected to predict the outcome. FIG. 3a is an illustrative screen shot of a volleyball real life video deployed in the video game environment for cognitive skill development of a user with respect to predicting whether the hitter 38 will hit or tip the ball. This cognitive skill development helps the user predict the opposing player's behavior better in a real volleyball game. Once the user initiates the training video, the video pauses at the point where the hitter 38 is about to take an action. Once the video is paused, the user is asked a question in a frame 40 integrated alongside the video on the device screen and is given a go ahead 36 to respond. FIG. 3b further depicts the user's response 42 to the question asked in the frame 40. Once the user responds 42 to the question, the video continues playing to show the real outcome in the real world video. The system records the user's response for future reference and may inform the user whether the user is right or wrong. Once the video is paused, different types of responses may be solicited from the user. FIGS. 3c and 3d illustrate a couple of other type of responses. While FIG. 3c illustrates one type of user response wherein the user draws the path 41 the ball will follow once the video is paused, FIG. 3d illustrates a response from the user wherein the user predicts the direction of the player or the ball by pressing left, right, up or down on the direction arrow 43.

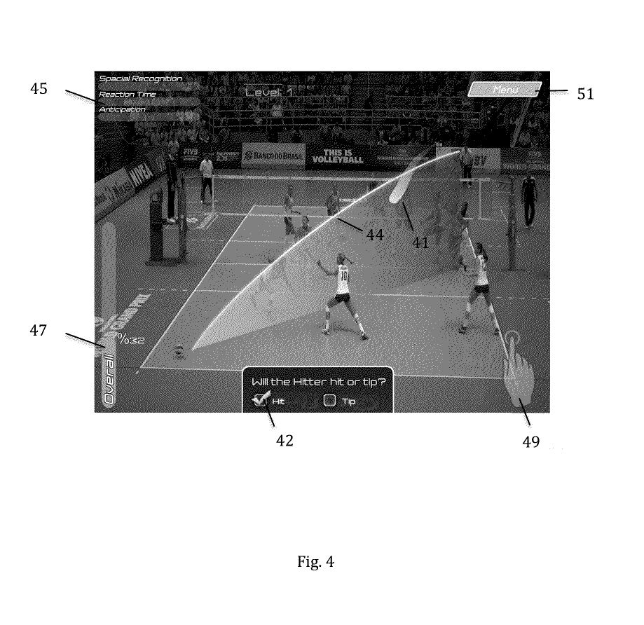

FIG. 4 illustrates another embodiment wherein the solution and analysis of user's response is displayed. Once the user predicts the path of the ball 41 and the paused real life video is played further, the video game environment highlights the actual path of the ball 44 and compares the user predicted path 41 to the actual path 44. Upon comparison of the user's input with the actual outcome, the system records the user's performance and displays an overall score 47 and individual scores 45 based on various facets of the user's response including but not limited to time taken to draw the path after video is paused (reaction time), closeness of drawn path to actual path (spatial recognition) and accuracy of final end point of drawn path (anticipation). The results and user's performance is recorded for future reference. Once the system records the user's performance the system may provide for the user an option 49 to navigate to the next video, level or the next trial or training exercise (cumulatively referred as trial). This next option 49 may be in the form of a tab, arrow, swipe or any other form prompting the user to optionally go to the next trial. The system may further provide a Menu option 51 that the user may optionally select to exit the game, access the game settings, see analytics, change level and the like. This menu option may also be used to logout current user and login as new user for customized training of such new user.

Numerous variations may be brought into the video game environment to seek varying responses from the user. These variations are entirely dependent on the type of activity for which cognitive training is being provided and the specific type of skill that needs to be developed. For example, different variations in the volleyball illustration could include predicting the hitter, predicting whether the hitter will hit short or deep, the ball will be hit directly at the passer or away and so on. All such variations in different activities are intended to be covered under the scope of this invention.

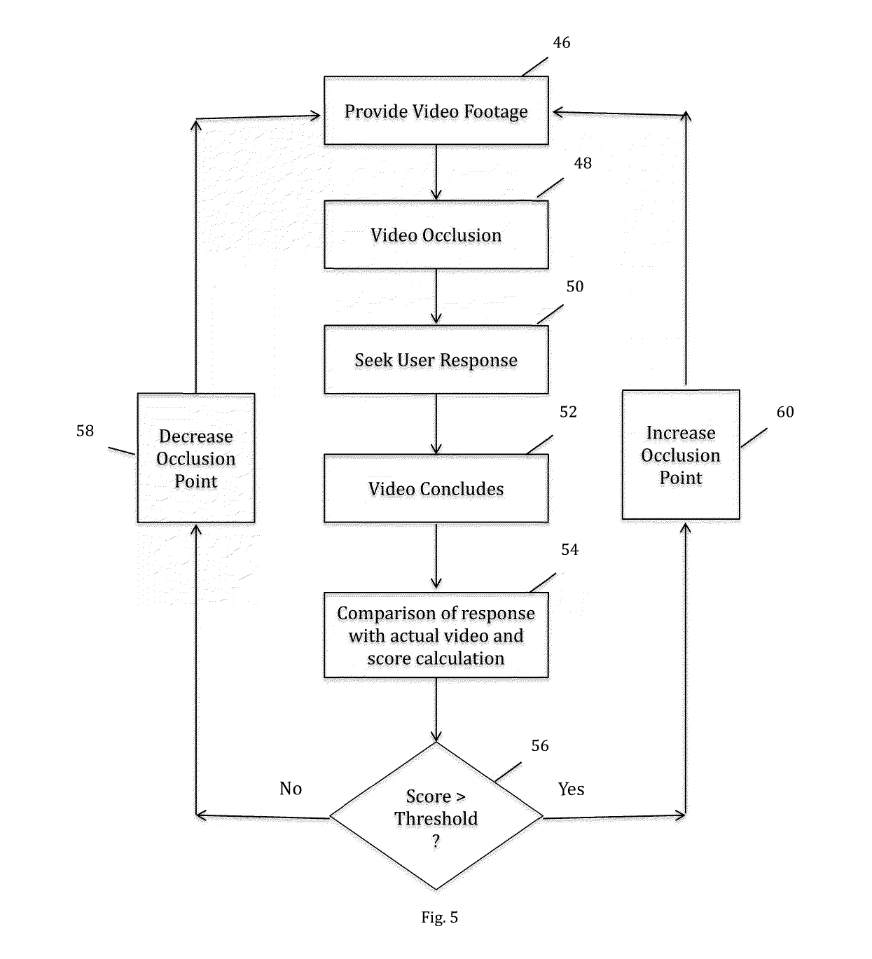

In the aforementioned illustrative embodiments, the video game environment relies on the principle of interrupting the real life video using various techniques to solicit a response (usually rapid) from the user. One technique used is known as video occlusion, which essentially means blocking the vision of the outcome of a specific activity in a video. The difficulty level of the game may be increased or decreased intelligently by the system by analyzing the performance of the user and correspondingly increasing or decreasing the video occlusion. For example, in the volleyball scenario, the performance may be adjudged based on various factors including closeness of drawn path of anticipated moving target and actual target movement in the previously recorded video or a comparison of the final position of the anticipated moving target that the user touched or drew, to the actual final position of the moving target in the previously recorded video etc. FIG. 5 illustrates a logic followed by the video game environment to increase or decrease the difficulty level of the game based on user performance. Once the real life video footage 46 is deployed in the video game environment, video occlusion 48 is used to interrupt the video at a predetermined point and the user response 50 is sought where the user is expected to predict an outcome. Once the user response 50 is recorded, the video concludes 52 and the system compares the user response to the actual outcome of the previously recorded video and calculates a score 54. If the calculated score is less than a pre set score threshold 56 then the difficulty level may be reduced by decreasing the occlusion point 58 to allow more information to the user. Alternatively, difficulty level may be reduced by slowing the video to allow the user more time or by providing cues to the user. If the calculated score is more than a pre set score threshold 56 then the difficulty level may be increased by increasing the occlusion point 60 to provide lesser information to the user. Alternatively, the difficulty level may be increased by increasing playback speed, or inducing distraction factors such as strobe light effects, number distractors, other objects in the field of view, screen shaking, crowd noise or other sound distractions.

### User Response

The video game environment disclosed herein is advantageous over the known cognitive skill enhancement games in terms of the amount of user interaction that is permitted in the disclosed video game environment. The video game environment seamlessly integrates touch interface in addition to the other traditional means of response input such as keyboard, mouse, game controller etc. The video game environment permits the user to use the touch screen interface of the device to submit a response directly over the recorded real life video deployed. For example, in the volleyball illustration, the user may submit responses such as drawing the path of the ball, drawing the movement of players, touching the end point of the ball, drawing or swiping fingers for a specific action, or touch buttons to respond to specific questions. This touch interface integration makes the disclosed system very convenient and highly interactive when used on tablets, mobiles and other similar devices.

In addition to touch interface, the video game environment may be adapted to seamlessly integrate with augmented reality systems to enable the user to interact in the game using hand and other gestures. For example, in the volleyball example hands gestures may be used to submit response to the temporally occluded video. These responses may include reacting to the path of the ball, reacting to the movement of the players, identifying end point of the ball and the players, responding to stimuli questions etc. The previously recorded real life video is played back in the augmented reality headset and paused at a certain point. The user is then required to move his or her hand in a specific manner to interact with the display. The game play is similar to touch interface but uses an augmented reality system instead.

### Performance Analytics and Data Representation

In the present invention the video game environment is capable of recording and storing the performance related data of each user. In one embodiment, the data is stored on a cloud server that may be retrieved later to track the overall improvement in the skills of the user. The statistics recorded includes game history such as scenarios completed, time spent on training, successful level completion, frequency of scoring higher than threshold score, highest and lowest scores and other performance indicators. The data on performance is displayed per cognitive and/or sports tasks such as reaction time, anticipation, goals saved, blocks, passes received, innocent people not shot etc.

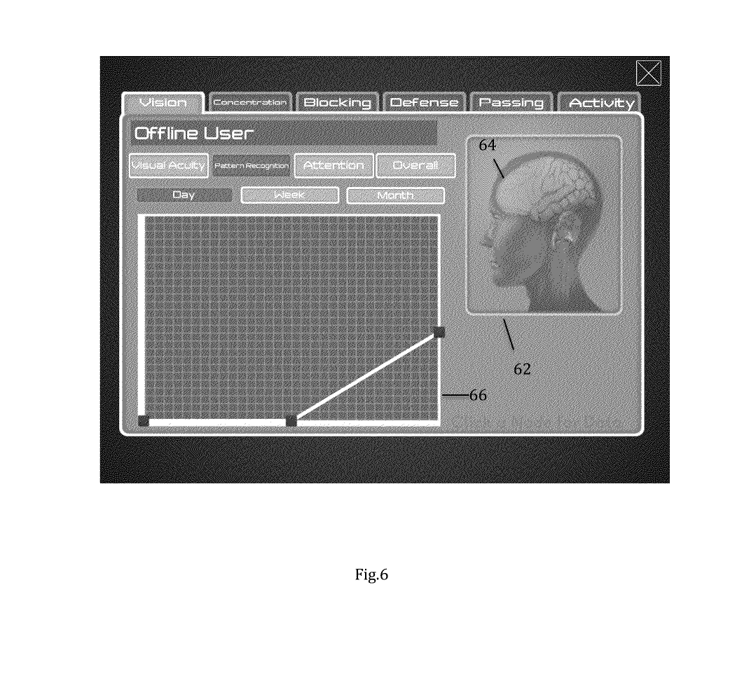

In one embodiment of the present invention, the data is presented and visualized with a brain image, where the specific areas of the brain are highlighted according to the skill or task. FIG. 6 is an illustrative screen shot of performance data and analytics display using a brain image 62 wherein different areas of the brain are highlighted 64 to depict the brain activity corresponding to a user's response to a specific task. In addition to the brain image a graph 66 may be used to depict the performance of the user over days, weeks and months.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A computer implemented training and cognitive skill improving method comprising:
deploying a real life video in a video game environment;
presenting said video game environment comprising of said real life video to a user;
creating an interruption in said real life video deployed in said video game environment;
soliciting said user's response to predict an outcome for a specific scenario based on said interruption; and
comparing said user's response with the actual outcome in said real life video.

2. The method of claim 1, further comprising storing and analyzing said user's response to measure improvement in cognitive and other skills.

3. The method of claim 1, further comprising increasing or decreasing the difficulty level of said video game environment automatically based on said user's performance.

4. The method of claim 1, further comprising inducing distraction factors to increase difficulty level.

5. The method of claim 1, further comprising automatic displaying of performance analytics data by highlighting active brain areas on a brain image corresponding to said user's response to specific tasks.

6. The method of claim 1, further comprising storing said real life video and corresponding Solutions file on a database to enable deployment of said real life video in said video game environment.

7. The method of claim 1, wherein said deploying of real life video in said video game environment is automatically done based on said user entered parameters.

8. The method of claim 1, wherein said interruption in said real life video is caused by temporal occlusion.

9. The method of claim 1, wherein said interruption in said real life video is caused by one of pausing said real life video at a specific point or presenting a blank screen to said user at a specific point.

10. The method of claim 1, wherein said user response is solicited using touch interface of a computing or mobile device.

11. The method of claim 1, wherein said user response is solicited using augmented reality system capturing said user's gestures.

12. A training and cognitive skill improving system comprising:
a storage means for storing real life videos;
a processor for deploying said real life videos from said storage means into a video game environment;
a video display screen for presenting said video game environment consisting of said real life video to a user; and
an input means for soliciting response from said user based on interruption of said real life video.

13. The system of claim 7, wherein said storage means is cloud server storage.

14. The system of claim 7, wherein said input means for soliciting response is a touch interface of a computing or mobile device.

15. The system of claim 7, wherein said input means for soliciting response is an augmented reality system capturing said user's gestures.

16. A computer readable storage medium containing computer readable instructions for implementing a method comprising:
deploying a real life video in a video game environment;
presenting said video game environment comprising of said real life video to a user;
creating an interruption in said real life video deployed in said video game environment;
soliciting said user's response to predict an outcome for a specific scenario based on said interruption; and
comparing said user's response with the actual outcome in said real life video.

17. The method implemented by computer readable storage medium of claim 16, further comprising storing and analyzing said user's response to measure improvement in cognitive and other skills.

18. The method implemented by computer readable storage medium of claim 16, further comprising increasing or decreasing the difficulty level of said video game environment automatically based on said user's performance.

19. The method implemented by computer readable storage medium of claim 16, further comprising inducing distraction factors to increase difficulty level.

20. The method implemented by computer readable storage medium of claim 16, further comprising automatic displaying of performance analytics data by highlighting active brain areas on a brain image corresponding to said user's response to specific tasks.

21. The computer readable storage medium of claim 16, wherein said deploying of real life video in said video game environment is automatically done based on said user entered parameters.

22. The computer readable storage medium of claim 16, wherein said interruption in said real life video is caused by temporal occlusion.

23. The computer readable storage medium of claim 16, wherein said interruption in said real life video is caused by one of pausing said real life video at a specific point or presenting a blank screen to said user at a specific point.
